(19) United States
(12) Patent Application Publication
(10) Pub. No.: US 2022/0368266 A1
(43) Pub. Date: Nov. 17, 2022

(54) DRIVE SYSTEM FOR DRIVING A FLUID COMPRESSION DEVICE AND ASSOCIATED POWER SUPPLY METHOD

(71) Applicant: IFP Energies nouvelles, RUEIL-MALMAISON (FR)

(72) Inventors: Alexandre BATTISTON, RUEIL-MALMAISON CEDEX (FR); Najla HAJE OBEID, RUEIL-MALMAISON CEDEX (FR); Siyamak SARABI, RUEIL-MALMAISON CEDEX (FR)

(21) Appl. No.: 17/761,229

(22) PCT Filed: Sep. 24, 2020
(86) PCT No.: PCT/EP2020/076733

§ 371 Date: Mar. 17, 2022

(30) Foreign Application Priority Data
Oct. 7, 2019 (FR) 1911069

(51) Int. Cl. H02P 27/08

(52) U.S. Cl. CPC H02P 27/085

(57) ABSTRACT

The invention is a drive system comprising an inverter comprising N arms, each arm including an upper half-arm and a lower half-arm each comprising at least one switching module, a rotary machine connected to the inverter, including a rotor having at least one magnetic element made from a modular magnetization material and a control device which, during magnetization controls the inverter to simultaneously for each one of m arms, set each switching module of the upper half-arm and turned on and each switching module of the lower half-arm is turned off, for each one of k other arms, set each switching module of the upper half-arm to be off and each switching module of the lower half arm to be on, and for each of the remaining arms, set each switching module to be off.

### CROSS-REFERENCE TO RELATED APPLICATIONS

Reference is made to PCT/EP2020/076733 filed Sep. 24, 2020, designating the United States, and French Application No. 19/11.069 filed Oct. 7, 2019, which are incorporated herein by reference in their entirety.

### BACKGROUND OF THE INVENTION

### Field of the Invention

The present invention relates to a drive system comprising an inverter, a rotary electric machine and a control device with the inverter comprising a first input, a second input, N arms connected in parallel between the first input and the second input, N being a natural number greater than or equal to 2, each arm comprising an upper half-arm and a lower half-arm in series, the upper half-arm being connected to the first input, the lower half-arm being connected to the second input, the upper half-arm and the lower half-arm of each arm being connected together at a corresponding output of the inverter, each upper half-arm and each lower half-arm comprising at least one switching module capable of switching between an on-state and an off-state, each first input and second input being intended to be connected to a respective terminal of a direct current source, each output being associated with a respective electric phase, the rotary machine comprising a stator and a rotor mobile in rotation relative to the stator about a rotation axis, the stator comprising N windings, each winding having an input and an output, the input of each winding being connected to a corresponding output of the inverter, the outputs of the stator windings being connected at a common point.

The invention also relates to a power supply method implemented by such a system, and to a compression assembly comprising such a system.

The invention is applied to the field of rotary electric machines, in particular for application to turbomachines, specifically a compressor or a turbocharger for an embedded application on board a vehicle.

### Description of the Prior Art

A conventional method of manufacturing a rotary machine comprises fastening already magnetized permanent magnets onto a rotor body with the rotor being then arranged in a cavity of a corresponding stator.

Such a method however involves many drawbacks. In particular, when assembling the rotor with the stator, the rotor (which comprises the already magnetized permanent magnets) generates magnetic forces likely to cause assembly problems with the stator, and at least one of an increased risk of rotor/stator shocks leading to damage.

In order to overcome such inconvenience, it has been proposed to produce a rotary electric machine by arranging in a stator cavity a rotor comprising elements (referred to as magnetic elements) made from a non-magnetized magnetic material. In the absence of magnetization, the electric machine assembly process is simplified. Once this assembly is achieved, a magnetic field is generated in the cavity by means of dedicated windings mounted in the stator, to magnetize the magnetic elements of the rotor.

However, such a manufacturing method is not entirely satisfactory.

Indeed, such a manufacturing method requires a dedicated structure for magnetizing the magnetic elements of the rotor, which has a negative impact on the size and the manufacturing cost of the rotary machine.

Besides, the rotary machine obtained with such a manufacturing method is not optimal within the context of driving a turbomachine, in particular a turbocharger for a vehicle. Indeed, in such an on-board application, the rotary machine is only used on an ad hoc basis. In this case, when it is not powered, the rotary machine generates a rotation resisting torque, which leads to no-load losses.

One goal of the invention thus is to provide a drive system that is simpler and more cost-effective, while generating smaller losses when the rotary machine it comprises is not operated.

### SUMMARY OF THE INVENTION

The object of the invention thus is a drive system of the aforementioned type wherein the rotor comprises at least one magnetic element made from a modular magnetization material, the control device being configured, during a step of magnetization of each magnetic element of the rotor, to control the inverter so as to simultaneously, during a predetermined magnetization time interval:
for each one among m arms of the inverter, forming each a current injection arm, m being a natural number ranging between 1 and N−1, control each switching module of the corresponding upper half-arm so as to set it to on-state and control each switching module of the corresponding lower half-arm so as to set it to off-state,
for each one among k arms of the inverter, selected from among the N−m other arms of the inverter, and forming each a current output arm, control each switching module of the corresponding upper half-arm so as to set it to off-state and control each switching module of the corresponding lower half-arm so as to set it to on-state, and
for each of the N−m−k other arms, control each corresponding switching module so as to set it to off-state.

Indeed, in such a drive system, during the magnetization step, the inverter is controlled in such a way that the magnetic field intended to magnetize the magnetic elements is generated by the stator windings that are commonly used to set the rotor in motion. Magnetization of the magnetic elements is thus made possible without any additional dedicated structure, which provides an advantage in terms of weight and manufacturing cost in relation to systems of the prior art.

Moreover, no connection is required between the inverter and the neutral point of the rotary machine. This is advantageous insofar as the neutral point is likely to be inaccessible.

Furthermore, such a drive system makes possible modification of at least one of the amplitude and the direction of magnetization of the magnetic elements of the rotor according to operating conditions. More precisely, in the drive system according to the invention, the direction and the amplitude of the magnetic field generated by the stator depends on the inverter magnetization outputs that are selected. Now, such a stator magnetic field has an influence on the magnetization of the magnetic elements of the rotor.

In particular, when operation of the rotary electric machine is no longer required for driving the fluid compression device, the drive system according to the invention advantageously allows, by judicious choice of the magnetization outputs, to apply to the magnetic elements a magnetic field having the effect of modifying, notably of substantially reducing or even cancelling the magnetization of the magnetic elements. Such magnetic elements are thus referred to as “modular magnetization” elements.

It follows that the rotary machine, which is mechanically coupled to the fluid compression device and is driven thereby even when it is not electrically operated, generates a braking force that is much lower than with a drive system of the prior art devoid of an inverter configured to modify the magnetization of the magnetic elements according to operating conditions.

Modular magnetization is relevant for an electrified turbocharger whose operation and power demands in motor and generator mode are transient (pulsed operation mode). The rotor made magnetically inert when operation of the electric rotary machine is no longer required limits the losses of the drive system when it is not used, in relation to a conventional drive system.

According to other advantageous aspects of the invention, the drive system comprises one or more of the following characteristics, taken in isolation or with all the technically possible combinations:
the control device comprises a means for detecting a magnetic field generated by the rotor, the control device being in addition configured, during the magnetization step, to:
   detect the magnetic field generated by the rotor;
   select each of the m current injection arms and of the k current output arms according to the detected magnetic field;
the drive system further comprises a first switching device, a second switching device and a load, the first switching device being connected in series between each arm and the second inverter input, the second switching device and the load being connected in series, and connected in parallel to the first switching device, the control device being configured to control, during the magnetization step, the first switching device to turn it to off and to control the second switching device to turn it to on;
the control device is further configured to carry out a rotary machine excitation step, subsequent to the magnetization step, the control device being configured to control the inverter during the excitation step according to a predetermined inverter control law to connect, successively in time, each inverter output to the first at least one of input and the second input of the inverter in order to drive the rotor in rotation about a corresponding rotation axis;
the duration of the magnetization time interval depends on at least one of the modular magnetization material and on the m current injection arms and the k current output arms; and
the duration of the magnetization time interval further depends on an impedance of the load.

Furthermore, the invention is a power supply method for a rotary electric machine using an inverter, the inverter comprising a first input, a second input, N arms connected in parallel between the first input and the second input, N being a natural number greater than or equal to 2, each arm comprising an upper half-arm and a lower half-arm in series, the upper half-arm being connected to the first input, the lower half-arm being connected to the second input, the upper half-arm and the lower half-arm of each arm being connected together at a corresponding output of the inverter, each upper half-arm and each lower half-arm comprising at least one switching module capable of switching between an on-state and an off-state, each first input and second input being configured to be connected to a respective terminal of a direct current source, each output being associated with a respective electric phase, the rotary machine comprising a stator and a rotor mobile in rotation relative to the stator about a rotation axis, the stator comprising N windings, each winding having an input and an output, the input of each winding being connected to a corresponding output of the inverter, the outputs of the stator windings being connected at a common point, the rotor comprises at least one magnetic element made from a modular magnetization material. The supply method comprises a step of magnetizing each magnetic element of the rotor comprising:
connecting each first input and second input to a respective terminal of a direct current source; and
simultaneously, during a predetermined magnetization time interval:
   for each one among m arms of the inverter, forming for each of the m arms a current injection arm, m being a natural number ranging between 1 and N−1, controlling each switching module of the corresponding upper half-arm to be on and controlling each switching module of the corresponding lower half-arm to be off;
   for each one among k arms selected from among the N−m other arms of the inverter, forming each into a current output arm, controlling each switching module of the corresponding upper half-arm to be off and controlling each switching module of the corresponding lower half-arm to be on; and
   for each of the N−m−k other arms, controlling each corresponding switching module to be off,
      as to simultaneously inject, into each winding, an electric current in order to generate, in the stator cavity, a non-zero magnetic field for magnetizing each magnetic element.

According to other advantageous aspects of the invention, the supply method comprises the following characteristic(s), taken in isolation or in combination:
the supply method further comprises, during the magnetization step:
   detecting a magnetic field generated by the rotor; and
   selecting each of the m current injection arms and of the k current output arms according to the detected magnetic field.

The supply method further comprises a rotary machine excitation step subsequent to the magnetization step which controls the inverter according to a predetermined inverter control law to connect, successively in time, each inverter output of at least one of the first input and the second input of the inverter to inject an electric current into the stator windings, to generate, in the stator cavity, a rotary magnetic field which rotates the rotor about the rotation axis.

Furthermore, the invention is a compression assembly comprising a fluid compression device and a drive system as defined above, the fluid compression device being coupled to the stator of the rotary machine of the drive system for drive thereof

According to an advantageous aspect of the invention is that the drive system comprises the fluid compression device in a turbocharger which combines a turbine and a compressor, notably for an internal-combustion engine, or a microturbine.

### BRIEF DESCRIPTION OF THE DRAWINGS

Other features and advantages of the invention will be clear from reading the description hereafter, given by way of non-limitative example, with reference to the accompanying figures wherein:

FIG. 1 schematically shows an assembly comprising a drive system according to the invention, associated with a direct current source;

FIG. 2 schematically shows in sectional view a rotary machine of the drive system of FIG. 1, in a transverse plane of the rotary machine according to an embodiment of the invention;

FIG. 3 schematically illustrates the electrical circuit of the assembly of FIG. 1, during a magnetization step wherein electric current is injected into a single winding of a stator of the rotary machine of FIG. 2;

FIG. 4 schematically shows in sectional view the stator of the rotary machine of FIG. 2, in a transverse plane of the rotary machine, during the magnetization step of FIG. 3; and

FIG. 5 is similar to FIG. 4 and shows a total magnetic field within a cavity of the stator.

### DETAILED DESCRIPTION OF THE INVENTION

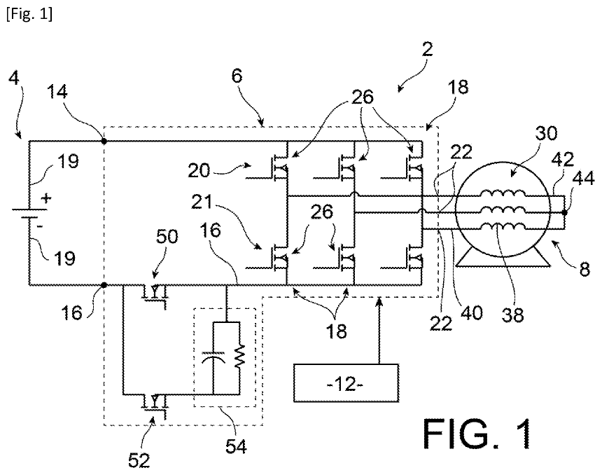

An example of a drive system 2 according to the invention is illustrated in FIG. 1. In this figure, a direct current source 4 is connected to the input of drive system 2.

Drive system 2 comprises an inverter 6, a rotary electric machine 8 and a control device 12.

Inverter 6 is configured to deliver an electric current from source 4 to windings (described hereafter) of rotary machine 8, in a selective manner.

Rotary machine 8 is intended to drive in rotation an element connected to its output shaft, in particular a fluid compression device, a compressor or a turbocharger for example.

Moreover, control device 12 is configured to control inverter 6.

Inverter 6 comprises a first input 14 and a second input 16, as well as N arms 18. N is a natural number greater than or equal to 2, equal to 3 for example, as illustrated in the figure.

Inputs 14, 16 of inverter 6 form the inlets of drive system 2. Each one of the first and second input 14, 16 is intended to be connected to a respective terminal 19 of source 4.

The N arms 18 are connected in parallel between first input 14 and second input 16 of inverter 6.

Each arm 18 comprises an upper half-arm 20 and a lower half-arm 21 in series, connected together at a midpoint forming a corresponding output 22 of inverter 6. Each output 22 is associated with a respective electrical phase, and it is connected to a corresponding winding of rotary machine 8.

For each arm 18, the corresponding upper half-arm 20 is connected to first input 14, while the corresponding lower half-arm 21 is connected to second input 16.

Each upper half-arm 20 and each lower half-arm 21 comprises at least one switching module 26 for switching between an off-state preventing electric current flow between the terminals thereof, and an on-state allowing electric current flow. For example, in FIG. 1, each upper half-arm 20 and each lower half-arm 21 comprises a switching module 26.

For example, switching modules 26 of inverter 6 are insulated-gate bipolar transistors IGBT or metal oxide semiconductor field effect transistors MOSFET.

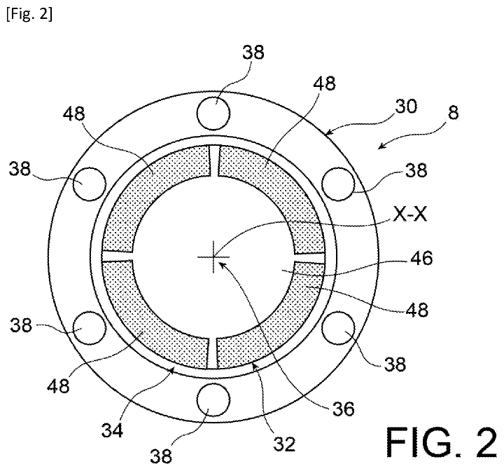

As schematically illustrated in FIG. 2 by way of non-limitative example, rotary machine 8 comprises a stator 30 and a rotor 32 which rotates relative to stator 30, about a rotation axis X-X.

More precisely, stator 30 comprises a cavity 34 in which rotor 32 is positioned.

Output shaft 36 of rotary machine 8, mentioned above, extends along rotation axis X-X and it is integral with rotor 32 which is driven in rotation about rotation axis X-X.

Stator 30 comprises N windings 38, arranged in a known manner, for generating a magnetic field in cavity 34 when traversed by an electric current. For example, windings 38 are arranged in such a way that the magnetic fields corresponding to two distinct windings 38 are mirror images of one another through a rotation by a non-zero angle multiple of 360° /N.

The magnetic field generated by windings 38 is notably intended to form an excitation magnetic field so as to drive rotor 32 in rotation about rotation axis X-X.

As described hereafter, the magnetic field generated by windings 38 is also intended to form a magnetization magnetic field to magnetize at least one magnetic element 48 (inserts for example) of rotor 32 prior to the rotation thereof

Each winding 38 comprises an input 40 and an output 42.

Input 40 of each winding 38 is connected to a corresponding output 22 of inverter 6. Moreover, outputs 42 of windings 38 are connected at a common point 44 which is referred to as the neutral point of rotary machine 8. Connection of outputs 42 at neutral point 44 is achieved, as appropriate, outside or inside rotary machine 8.

Rotor 32 comprises at least one magnetic element 48 made from a modular magnetization material.

A modular magnetization material is understood to be, in the sense of the present invention, a ferromagnetic material, preferably a soft ferromagnetic material or a semi-hard ferromagnetic material.

A soft ferromagnetic material is a ferromagnetic material having a coercive field below 1000 A.m−1(Ampere per meter).

Furthermore, a semi-hard ferromagnetic material is a ferromagnetic material having a coercive field ranging between 1000 A.m−1 and 100,000 A.m−1, preferably between 1000 A.^{m-1} and 10,000 A.^{m-1} .

Such a material is, for example, an alloy known as FeCrCo, containing iron, chromium and cobalt, or an alloy known as AlNiCo, containing aluminium, nickel and cobalt.

For example, each magnetic element 48 is an insert integral with a body 46 of rotor 32. For example, each magnetic element 48 is integrated in body 46 or arranged on the periphery of body 46. According to an aspect, it can have the shape of a ring.

In this case, rotor 32 advantageously comprises magnetic elements 48 circumferentially arranged around rotation axis X-X, preferably at regular angular intervals.

Preferably, each insert 48 extends along rotation axis X-X.

According to a variant (not shown), magnetic element 48 forms all or part of the body of rotor 32.

As described above, control device 12 is configured to control inverter 6. In particular, control device 12 is configured to control inverter 6 in order to selectively connect outputs 22 of inverter 6 to at least one of the first input 14 and the second input 16 of inverter 6.

More precisely, control device 12 is configured to control inverter 6, during a step of magnetizing each magnetic element 48 of rotor 32, to cause a direct electric current to flow through windings 38 of stator 30 to generate, in cavity 34, a non-zero magnetic field intended to provide magnetization within each magnetic element 48.

In particular, control device 12 is configured to control inverter 6, during the magnetization step, so as to simultaneously, during a predetermined magnetization time interval:
for each one among m arms 18 of inverter 6, forming each arm into a current injection arm, m being a natural number ranging between 1 and N−1, controlling each switching module 26 of the corresponding upper half-arm 20 so to be on and controlling each switching module 26 of the corresponding lower half-arm 21 to be off;
for each one among k arms 18 among the N−m other arms 18 of inverter 6, is a natural number ranging between 1 and N−m, forming each arm into a current output arm, controlling each switching module 26 of the corresponding upper half-arm 20 to turn it off and controlling each switching module 26 of the corresponding lower half-arm 21 to turn it on; and
for each of the N−m−k other arms 18, forming each other arm into an inactive arm and controlling each corresponding switching module 26 to be off

In a preferred embodiment, the value of k is N−m, which means there is no inactive arm during the magnetization step.

The m current injection arms and the k current output arms are predetermined for example.

Thus, during the magnetization step, the electric current from source 4 is sent to first input 14, then through upper half-arms 20 of the m current injection arms, to windings 38 connected to the current injection arms. The current then reaches common point 44, subsequently it circulates in the opposite direction, that is from common point 44 to the outside of rotary machine 8, through the k other windings 38 connected to the current output arms. The current is then sent to second input 16 through lower half-arms 21 of the current output arms. Switching modules 26 of the N−m−k other arms 18 are off, so no current flows through the windings connected thereto.

A winding 38 connected to a current injection arm or to a current output arm is referred to hereafter as “active winding”.

The electric current path described above corresponds to the situation where first input 14 is brought to a higher electric potential than second input 16. In the opposite case, the electric current follows the reverse path.

Such a current flow in active windings 38 leads to the generation, by each one of them, of a magnetic field in a corresponding direction. By judicious selection of the m current injection arms and the k current output arms, a non-zero total magnetic field intended to magnetize each magnetic element 48 is generated in cavity 34 during the magnetization time interval.

Windings 38 are arranged to generate magnetic fields in different directions. Moreover, for a given winding 38, the direction of the magnetic field generated by the winding depends on the direction of the electric current flowing therethrough (i.e. from its input 40 to common point 44, or from common point 44 to its input 40). The result is that the amplitude (and the direction) of the total magnetic field in cavity 34 varies depending on whether the arms 18 act as current injection arms or act as current output arms. Therefore, the minimum duration enabling magnetization of each magnetic element 48, that is the minimum duration of the magnetization time interval, varies depends on the selected current injection arm/current output arm combination.

Preferably, the duration of the magnetization time interval is also selected according to the modular magnetization material from which each magnetic element 48 is made. Indeed, the magnetization time interval corresponds to the time interval during which each magnetic element 48 is subjected, during the magnetization step, to the magnetic field intended to cause its magnetization. For a given amplitude of such a magnetic field, the duration of the magnetization time interval is selected to ensure magnetization of each magnetic element 48.

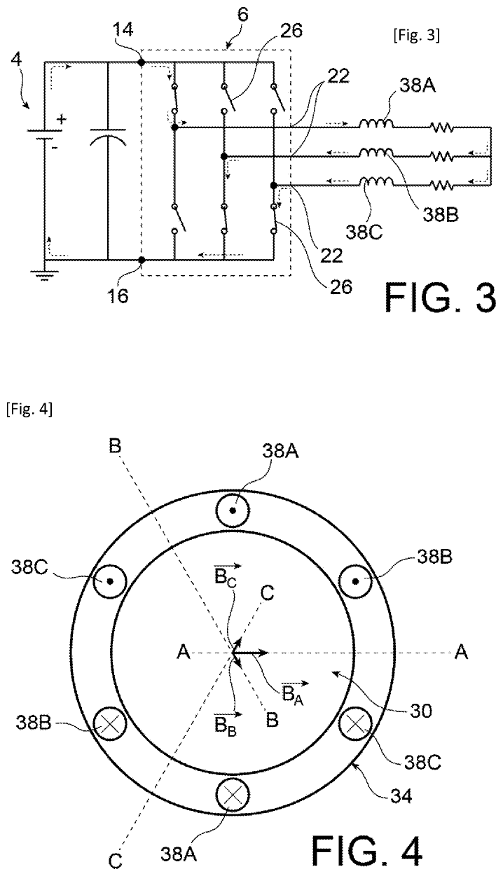

In the example of FIG. 3, which illustrates the operation of the drive system 2 of FIG. 1, rotary machine 8 is a three-phase machine. Number m is selected to be equal to 1and number k to be equal to 2.Moreover, the path of the electric current is illustrated by dotted arrows.

In this example, during the magnetization step, control device 12 controls inverter 6 so that, for the single current injection arm, switching module 26 of the corresponding upper half-arm 20 is in on-state and switching module 26 of the corresponding lower half-arm 21 is in off-state. As a result, the winding denoted by 38A, connected to output 22 of the current injection arm, is traversed by the electric current delivered by source 4 in a direction from first inverter input 14 to common point 44 of rotary machine 8.

Simultaneously, control device 12 controls inverter 6 so that, for each of the two current output arms, switching module 26 of the corresponding upper half-arm 20 is off and switching module 26 of the corresponding lower half-arm 21 is on. As a result, the windings denoted by 38B, 38C, which are respectively connected to the current output arms, are traversed by the electric current in a direction from common point 44 of rotary machine 8 to second input 16 of inverter 6.

From windings 38 being assumed identical, it follows from the above that the current flowing through winding 38A has an intensity im, while the current flowing through each of the windings 38B, 38C has an intensity im/2.

Therefore, as illustrated in FIG. 4, winding 38A generates, along a corresponding axis A-A, a magnetic field \vec{B_{A}} of amplitude Bm depending on current intensity im. Besides, each winding 38B and 38C generates, along a respective axis B-B, C-C, a magnetic field respectively denoted by \vec{B_{B}}, \vec{B_{C}}, of amplitude Bm/2.

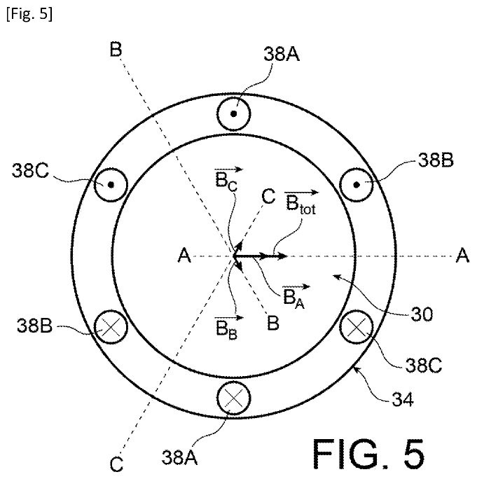

Due to the direction of flow of the electric current through windings 38 of rotary machine 8 during the magnetization step, the angle oriented between magnetic fields \vec{B_{B}} and \vec{B_{A}} has a positive value of 60° , and the angle oriented between magnetic fields \vec{B_{A}} and \vec{B_{C}} also has a positive value of 60° . It follows that the total magnetic field \vec{Bₜₒₜ} , which is the resultant of magnetic fields \vec{B_{A}} , \vec{B_{B}} and \vec{B_{C}} , is collinear with \vec{B_{A}} and has an amplitude of 3Bm/2,as shown in FIG. 5.

For a sufficient amplitude of the total magnetic field and a sufficient duration of the magnetization time interval, a magnetization appears within each magnetic element 48 and persists at the end of the magnetization time interval.

It may be noted that, in FIGS. 4, 5, stator 30 comprises a single pole per winding 38. However, a larger number of poles per winding 38 is possible.

Furthermore, control device 12 is advantageously configured to carry out the magnetization step prior to a step of exciting rotary machine 8. Such an excitation step comprises controlling inverter 6 to inject into windings 38 of stator 30 an electric current in order to generate, in cavity 34, a magnetic excitation field intended to cause rotation of rotor 32 about rotation axis X-X.

More precisely, control device 12 is configured to control inverter 6, during the excitation step, according to a predetermined inverter control law so as to connect, successively in time, first input 14 and second input 16 of inverter 6 to each output 22 of inverter 6.

The purpose of such an excitation step is to cause rotation of rotor 32 about its axis X-X. This is made possible by the presence of a magnetization within magnetic elements 48 of rotor 32, as a result of the magnetization step described above.

Optionally, drive system 2 further comprises a first switching device 50, a second switching device 52 and a load 54. As shown in FIG. 1, first switching device 50 is connected in series between each arm 18 and second input 16 of inverter 6. Moreover, second switching device 52 and load 54 are connected in series, and connected in parallel to first switching device 50.

Each of first switching device 50 and second switching device 52 is capable of switching between an off-state preventing flow of an electric current and an on-state enabling flow of an electric current.

Each switching device 50, 52 is a MOSFET transistor or a relay.

According to this variant, control device 12 is advantageously configured to simultaneously control, during the magnetization step, first switching device 50 to turn it off and second switching device 52 to turn it on.

In this case, during the magnetization step, load 54 is inserted into the circuit through which the electric current travels between first input 14 and second input 16, so that the intensity of the current flowing in windings 38 during the magnetization step also depends on the impedance of load 54.

Addition of such a load 54 is advantageous insofar as the current intensity during the magnetization step is reduced in relation to the intensity of the current that would flow in the absence of load, notably in the case of rotary electric machines with low stator inductances (of the order of a few microhenrys for example). The components of inverter 6 and of stator 30 are less likely to be damaged by overintensities.

The operation of drive system 2 is now described.

During a step of assembling rotary machine 8, magnetic elements 48 of rotor 32 have no magnetization and rotor 32 is arranged in cavity 34 of stator 30.

Moreover, during a step of assembling drive system 2, input 40 of each winding 38 of stator 30 is connected to a corresponding output 22 of inverter 6.

Each first input 14 and second input 16 of inverter 6 is then connected to a respective terminal of direct current source 4.

Then, during the magnetization step, control device 12 controls inverter 6 in such a way that, during the magnetization time interval:
for each arm 18 among the m current injection arms, each switching module 26 of its upper half-arm 20 is on and each switching module 26 of its lower half-arm 21 is off;
for each arm 18 among the k current output arms, each switching module 26 of its upper half-arm 20 is off and each switching module 26 of its lower half-arm 21 is on; and for each arm 18 among the N−m−k inactive arms, which are neither current injection arms nor current output arms, each corresponding switching module 26 is off

It follows that an electric current flows through each active winding 38 so as to generate, in cavity 34 of stator 30, a magnetic field intended to magnetize each magnetic element 48.

Then, during the step of exciting rotary machine 8, subsequent to the magnetization step, control device 12 controls inverter 6 according to a predetermined inverter control law (pulse width modulation control for example) to connect, successively in time, first input 14 and second input 16 of inverter 6 to each inverter output 22 in order to inject excitation currents into each winding 38 of stator 30 to generate, in cavity 34 of stator 30, a rotary magnetic field which rotates the rotor 32 in rotation about rotation axis X-X.

In a variant, control device 12 also comprises a means of detecting a magnetic field generated by rotor 32 with the origin of the magnetic field being the magnetization of magnetic elements 48. In this case, control device 12 is also configured to carry out, notably after the step of exciting rotary machine 8, an additional magnetization step that differs from the magnetization step described above only in that control device 12 further performs:
detection of the magnetic field generated by rotor 32, and
selection of the m current injection arms and the k current output arms according to the magnetic field detected.

Such a feature is advantageous insofar as judicious choice of the magnetization outputs leads to the generation, by means of the stator, a magnetic field intended to modulate, in particular to reduce or even to cancel the magnetization of magnetic elements 48. This has the effect of reducing the losses due to rotary machine 8 when operation of the rotary machine 8 is no longer required, in relation to a situation where such a modulation of the magnetic elements magnetization would not be carried out.

Selection of the current injection arms and of the current output arms according to the detected magnetic field is for example achieved from calibration data pre-recorded in control device 12. According to another example, such a selection results from the implementation, by control device 12, of an optimization calculation allowing to best approximate a desired magnetic field generated by the magnetic field likely to be generated by the stator.

1-11. (canceled)

12. A drive system comprising an inverter, a rotary electric machine and a control device,
the inverter including a first input, a second input, N arms connected in parallel between the first input and the second input with N being a natural number greater than or equal to 2;
each arm including an upper half-arm and a lower half-arm connected in series, the upper half-arm being connected to the first input, the lower half-arm being connected to the second input, the upper half-arm and the lower half-arm of each arm being connected together at a corresponding output of the inverter;
each upper half-arm and each lower half-arm comprising at least one switching module capable of switching between an on and an off state;
each first input and second input being configured to be connected to a different terminal of a direct current source and each output being connected to an electric phase;
the rotary machine including a stator and a rotor which rotates relative to the stator about a rotation axis, the stator comprising N windings with each winding having an input and an output, the input of each winding being connected to a corresponding output of the inverter, the outputs of the windings of the stator being connected to a common point;
the rotor including at least one magnetic element made from a modular magnetization material;
the control device being configured, during a step of magnetization of each magnetic element of the rotor, to control the inverter to simultaneously, during a predetermined magnetization time interval to magnetize the magnetic elements:
for each one of m arms of the inverter formed into a current injection arm, with m being a natural number ranging between 1 and N−1, controlling each switching module of the corresponding upper half-arm to be on, and controlling each switching module of the corresponding lower half-arm to be off,
for each one of k arms of the inverter, selected from N−m other arms of the inverter, and forming each selected other arm into a current output arm, controlling each switching module of the corresponding upper half-arm to be off and controlling each switching module of the lower half-arm to be on, and
for each of the N−m−k other arms, controlling each other arm with the switching module to be off.

13. A drive system as claimed in claim 12, wherein the control device comprises a means for detecting a magnetic field generated by the rotor, the control device in addition being configured during the magnetization step to:
detect the magnetic field generated by rotor; and
to select each of the m current injection arms and each of the k current output arms according to the detected magnetic field.

14. A drive system as claimed in claim 12, comprising a first switching device, a second switching device and a load;
the first switching device being connected in series between each current injection arm and a second input of the inverter;
the second switching device and the load being connected in series and being connected in parallel to the first switching device; and
the control device being configured to control, during the magnetization step, the first switching device to be off and to control second switching device to be on.

15. A drive system as claimed in claim 13, comprising a first switching device, a second switching device and a load;
the first switching device being connected in series between each arm and second input of the inverter;
the second switching device and the load being connected in series and connected in parallel to the first switching device; and
the control device being configured to control, during the magnetization step, the first switching device to be off and to control second switching device to be on.

16. A drive system as claimed in claim 12, wherein the control device is configured to carry out a rotary machine excitation step, subsequent to the magnetization step to control the device being configured to control the inverter during the rotary machine excitation step according to a predetermined inverter control law to connect, successively in time, each output of the inverter to at least one of the first input and the second input of the inverter to rotate the rotor around a rotational axis.

17. A drive system as claimed in claim 13, wherein the control device is configured to carry out a rotary machine excitation step, subsequent to the magnetization step to control the device being configured to control the inverter during the excitation step according to a predetermined inverter control law to connect, successively in time, each output of the inverter to at least one of the first input and the second input of the inverter to rotate the rotor around a rotational axis.

18. A drive system as claimed in claim 14, wherein the control device is configured to carry out a rotary machine excitation step, subsequent to the magnetization step to control the device being configured to control the inverter during the excitation step according to a predetermined inverter control law to connect, successively in time, each output of the inverter to at least one of the first input and the second input of the inverter to rotate the rotor around a rotational axis.

19. A drive system as claimed in claim 15, wherein the control device is configured to carry out a rotary machine excitation step, subsequent to the magnetization step to control the device being configured to control the inverter during the excitation step according to a predetermined inverter control law to connect, successively in time, each output of the inverter to at least one of the first input and the second input of the inverter to rotate the rotor around a rotational axis.

20. A drive system as claimed in claim 12, wherein duration of the magnetization time interval depends on at least one of the modular magnetization material used to construct the at least one magnet k element on the m current injection arms and the k current output arms.

21. A drive system as claimed in claim 13, wherein duration of the magnetization time interval depends on at least one of the modular magnetization material used to construct the at least one magnet k element and on the m current injection arms and the k current output arms.

22. A drive system as claimed in claim 14, wherein duration of the magnetization time interval depends on at least one of modular magnetization material used to construct the at least one magnet k element and on the m current injection arms and the k current output arms.

23. A drive system as claimed in claim 16, wherein duration of the magnetization time interval depends on at least one of modular magnetization material used to construct the at least one magnet k element and on the m current injection arms and the k current output arms.

24. A drive system as claimed in claim 22, wherein duration of the magnetization time interval further depends on impedance of a load.

25. A power supply method for a rotary electric machine using an inverter comprising a first input, a second input, N arms connected in parallel between the first input and the second input, N being a natural number greater than or equal to 2,each arm comprising an upper half-arm in series with a lower half-arm, the upper half-arm being connected to the first input, the lower half-arm being connected to the second input, each upper half-arm and each lower half-arm being connected together at an output of the inverter; each upper half-arm and each lower half-arm comprising at least one switching module configured to switch between on and off, each of the first input and the second input being configured to connect to a different terminal of a direct current source, each output being an output of an electric phase, the rotary machine comprising a stator and a rotor which rotates relative to stator about a rotation axis, the stator comprising N windings, each winding having an input and an output, the input of each winding being connected to an output of the inverter with N outputs of windings of the stator being connected at a common point; the rotor comprises at least one magnetic element made from a modular magnetization material;
the power supply method comprising magnetizing each magnetic element of rotor comprising steps of:
connecting each of the first input and the second input to the different terminal of the direct current source; and
simultaneously, during a predetermined magnetization time interval for each of the m arms of the inverter, forming each of the arms into a current injection arm with m being a natural number ranging between 1 and N−1;
controlling each switching module of a corresponding upper half-arm to turn on and controlling each switching module of a corresponding lower half-arm to turn off;
for each of the k arms selected from among the N−m arms of the inverter, forming each one of the selected k arms into a current output arm, controlling each switching module of the corresponding upper half-arm to turn off and controlling each switching module of a corresponding lower half-arm to turn on; and for each of the N−m−k other arms, controlling each corresponding switching module to turn off; and
simultaneously injecting into each winding an electric current which generates, in a cavity of the stator, a non-zero magnetic field for magnetizing each magnetic element.

26. A supply method as claimed in claim 25, comprising, during the magnetization step:
detecting a magnetic field generated by the rotor; and
selecting each of the m current injection arms and each of the k current output arms according to the detected magnetic field.

27. A supply method as claimed in claim 25, comprising a rotary machine excitation step subsequent to the magnetization step comprising controlling the inverter according to a predetermined inverter control law to successively connect each output of the inverter to at least one of the first input and the second input of the inverter to inject an electric current into the windings of the stator, to generate, in the cavity of the stator, a rotary magnetic field which rotates the rotor around the rotation axis.

28. A supply method as claimed in claim 26, comprising a rotary machine excitation step subsequent to the magnetization step comprising controlling the inverter according to a predetermined inverter control law to successively connect each output of the inverter to at least one of the first input and the second input of the inverter to inject an electric current into the windings of the stator, to generate, in the cavity of the stator, a rotary magnetic field which rotates the rotor around the rotation axis.

29. A compression assembly comprising a fluid compression device and a drive system as claimed in claim 12, wherein the fluid compression device is coupled to the stator of the rotary machine for driving the system to rotate the compression device.

30. A compression assembly comprising a fluid compression device and a drive system as claimed in claim 13, wherein the fluid compression device is coupled to the stator of the rotary machine for driving the system to rotate the compression device.

31. A compression assembly as claimed in claim 29, wherein the fluid compression device is a turbocharger comprising a turbine and a compressor.
